(19) United States
(12) Patent Application Publication
(10) Pub. No.: US 2011/0052752 A1
(43) Pub. Date: Mar. 3, 2011

(54) ROTATIONAL PET-FOOD FORMULATION AND METHOD

(75) Inventors: Lucas Saxe, Laguna Beach, CA (US); Michael Farmer, Southlake, TX (US)

(73) Assignee: GlobalOne Pet Products, Inc., Southlake, TX (US)

(21) Appl. No.: 12/703,133

(22) Filed: Feb. 9, 2010

Related U.S. Application Data
(60) Provisional application No. 61/236,814, filed on Aug. 25, 2009.

(51) Int. Cl. A23K 1/16; B65D 77/00; A23K 1/18

(52) U.S. Cl. 426/2; 426/397; 426/411; 426/410

(57) ABSTRACT

Compositions and methods are disclosed for providing a rotational pet-food diet to a pet. Rotational pet-food formulas are provided that enable a pet owner to cycle a pet's diet through a sequence of different pet-food formulas that are digestively compatible and developed to nutritionally complement one another. The rotational pet-food formulas may be packaged together and sold as a single point-of-purchase unit.

### RELATED APPLICATIONS

This application claims the benefit of U.S. Provisional Patent Application Ser. No. 61/236,814, filed Aug. 25, 2009, the entire contents of which are incorporated herein by reference.

### BACKGROUND

1. Field of the Invention

The invention disclosed herein relates generally to the field of pet nutrition. More specifically, the invention relates to providing pets a healthy diet by cycling through a sequence of rotational pet-food formulas that are digestively compatible and developed to nutritionally complement one another.

2. Description of the Related Art

Traditionally pets are fed food consisting of a single stand-alone formula for life stages—puppy, adult and senior. Often a particular pet food is recommended to a pet owner by a breeder or veterinarian. This mono-formula pet-food diet is then fed to the pet for extended periods of time because of concern over digestive issues when transitioning the pet between pet-food formulas. Thus, when a pet finishes a bag of pet-food formula, the owner will replace the finished bag with a new bag of the same pet-food formula.

Limiting a pet's diet to a single formula may present several problems. For example, often a pet-food formula provides nutrients from a single or limited source of nutrients. In turn, this exposure may cause saturation of various ingredients which could influence an allergy response. In addition, a mono-formula pet-food diet may limit exposure to a healthy variety of nutrients.

### SUMMARY

Rotational pet-food formulas are provided that enable a pet owner to cycle a pet's diet through a sequence of different pet-food formulas developed to nutritionally complement one another. Each rotational pet-food formula is designed to minimize or eliminate any digestive issues that would otherwise occur when switching a pet's diet from one pet-food formula to the next.

A rotational pet-food system is comprised of two or more rotational pet-food formulas. The digestive compatibility and nutritional complementariness of each rotational pet-food formula in a rotational pet-food system enables the rotational pet-food system to deliver a more-comprehensive and balanced nutrient platform not found in any single pet-food formula. The individual rotational pet-food formulas comprising a rotational pet-food system work together as a complete nutritional system. Although the rotational pet-food formulas in a rotational pet-food system are designed to work together synergistically to deliver enhanced nutrition, each rotational pet-food formula is designed to individually meet the nutritional requirements of a pet and those set by the Association of American Feed Control Officials (AAFCO).

To ensure that all rotational pet-food formulas in a rotational pet-food system complement one another nutritionally, and to ensure that the transition from one rotational pet-food formula to the next will not cause digestive issues, each rotational pet-food formula in a rotational pet-food system may exhibit shared characteristics. First, each rotational pet-food formula may exhibit the same or substantially similar nutrient composition. For example, each rotational pet-food formula in a rotational pet-food system may advantageously comprise approximately the same percentage balance of proteins, fats, fibers, and carbohydrates. Second, each rotational pet-food formula may use complementary proteins, grains, fruits, fiber sources, vegetables, and chondroprotective agents. Third, each rotational pet-food formula may achieve consistent ingredient levels by leveling of proteins, fats, grains, fiber sources, vitamins, and minerals. Fourth, each rotational pet-food formula may utilize kibbles of consistent size, shape, and texture.

In some embodiments, the rotational pet-food formulas in a rotational pet-food system may be formulated to contain beneficial ingredients. For example, the formulas in a rotational pet-food system may comprise regular ingredients, or the formulas may comprise organic ingredients. In addition, some rotational pet-food formulas may be free of grains.

The rotational pet-food formulas in a rotational pet-food system are designed to deliver proper nutrient exposure. Formulating the rotational pet-food formulas with balanced levels of multiple protein sources helps to ensure proper nutrient exposure. In addition, formulating the rotational pet-food formulas with balanced levels of multiple carbohydrate sources also helps ensure proper nutrient exposure. Furthermore, formulating the rotational pet-food formulas using appropriate vitamins and minerals helps to ensure proper nutrition.

By limiting the number of ingredients in each rotational pet-food formula, it is possible to ensure adequate levels of each ingredient are used. Furthermore, limited ingredient crossover among rotational pet-food formulas in a rotational pet-food system ensures that the likelihood of over-saturation to ingredients is minimized.

In addition to nutritional benefits, feeding a pet a rotational diet that cycles among the rotational pet-food formulas in a rotational pet-food system offers a variety of flavor and ingredient sources that keep pets interested in proper feeding.

Although each rotational pet-food formula in a rotational pet-food system may be consumed in any order, advantageously the rotational pet-food formulas may be consumed in a particular order. After a cycle is completed by finishing each rotational pet-food formula in the rotational pet-food system, a new cycle may commence.

In some embodiments, a rotational pet-food system may be comprised of as few as two rotational pet-food formulas. In other embodiments, the rotational pet-food system may comprise three rotational pet-food formulas. However, there is no limit to the number of rotational pet-food formulas that may comprise a rotational pet-food system. For example, in some embodiments, a rotational pet-food system may be comprised of twelve rotational pet-food formulas. In some twelve-formula embodiments, the rotational pet food formulas may be formulated according to the varied nutritional needs of a pet by calendar month.

The quantity of rotational pet-food formula contained in each package, can, bag, box or other unit of rotational pet-food formula may vary by any amount. For example, in some embodiments, the rotational pet-food formulas may comprise a single-serving can or bag. In other embodiments, the rotational pet-food formulas may comprise a large multi-serving can or bag whose size is only limited by the ability of the can or bag to keep the rotational pet-food formulas fresh.

In some embodiments, the size of one or more packages of rotational pet-food formula in a rotational pet-food system may be different than the size of packages of other rotational pet-food formulas in that system. For example, in an embodiment of a rotational pet food system comprising three rotational pet-food formulas—Formulas A, B, and C—the size of a can or bag of Formula A may be twice the size of a can or bag of Formula B or C. In this embodiment, a pet may consume Formula A for 50% of a rotational pet-food cycle, Formula B for 25% of a rotational pet-food cycle, and Formula C for the remaining 25% of a rotational pet-food cycle.

In other embodiments, the size of packages of rotational pet-food formula in a rotational pet-food system may be equal. For example, in some embodiments, the size of cans or bags of a rotational pet-food system comprising Formulas A, B, and C may be equal, such that a pet may consume Formula A for 33% of a rotational pet-food cycle, Formula B for 33% of a rotational pet-food cycle, and Formula C for the remaining 33% of a rotational pet-food cycle.

The duration of a rotational pet-food cycle may be as short or as long as desired. For example, in some embodiments, the rotational pet-food system may comprise two rotational pet-food formulas which may be packaged in single-serving cans or bags. In one meal, the pet may eat a first rotational pet-food formula. In the next meal, the pet may eat the other rotational pet-food formula. In these embodiments, the rotational cycle is as short as two meal periods. These embodiments also achieve improved freshness because the cans or bags of rotational pet-food formula are not opened until they are ready to be consumed, and they are consumed in their entirety once opened.

In some embodiments, the duration of a rotational pet-food cycle may be relatively long. The three primary factors that determine the duration of a rotational pet-food cycle are the number of different rotational pet-food formulas that comprise a rotational pet-food system, the size of each bag of rotational pet-food formula, and the serving size of each pet-food formula that is fed to the pet. The duration of a rotational pet-food cycle may be increased by utilizing larger bags to hold each rotational pet-food formula.

In some embodiments, the rotational pet-food formulas of a rotational pet-food system may comprise dry ingredients. In other embodiments, the rotational pet-food formulas of a rotational pet-food system may comprise wet ingredients. Rotational pet-food formulas comprising wet ingredients may be sold in cans. Rotational pet-food formulas packaged in cans may be sold individually or in multi-packs comprising any number of cans. In addition, in other embodiments, a rotational pet-food system may comprise rotational pet-food formulas comprising dry ingredients that are rotationally compatible with other rotational pet-food formulas comprising wet or semi-moist ingredients. These embodiments advantageously offer a pet variety between dry food, wet food, and semi-moist food.

In other embodiments, the rotational pet-food formulas of a rotational pet-food system may include, but are not limited to, semi-moist pet food, pet treats, rawhide chews and pet snacks.

Rotational pet-food systems can be formulated for any type and breed of pet. Although dogs and cats are the most common pets for which many rotational pet-food systems would be formulated, rotational pet-food systems can also be formulated for other mammals, reptiles, birds, fish, and amphibians. Furthermore, rotational pet-food systems can be formulated for any breed of dog or cat.

In addition, rotational pet-food systems can be formulated for pets of any age range. For example, different rotational pet-food systems can be formulated for puppies, adult dogs, senior dogs, as well as kittens, adult cats, and senior cats. Furthermore, rotational pet-food systems can be formulated according to activity lifestyle. For example, one rotational pet-food system can be formulated for an indoor dog or cat, while a different rotational pet-food system can be formulated for an outdoor dog or cat.

Each rotational pet-food formula comprising a rotational pet-food system may be individually packaged in its own bag or can. Packaging of rotational pet-food formulas may comprise many materials, including paper, plastic, aluminum, steel, woven materials, coated materials, and lined materials. Individual packaging of each bag or can of rotational pet-food formula enhances freshness because each bag or can need not be opened until the previous pet-food formula in the rotational cycle is finished.

Each bag or can of rotational pet-food formula in a rotational pet-food system may be packaged together as a multi-pack to form a single point-of-purchase (POP) unit. Offering every bag or can of rotational pet-food formula in a rotational pet-food system in a single POP unit provides increased convenience for consumers. The POP unit may be put together as a package, carton, or any other container. The POP unit may offer added protection for the individual bags or cans of rotational pet-food formula. Also, the POP units may be designed to reduce shelf space. In addition, the POP units may have carry handles or straps designed to facilitate transport of the POP unit by consumers. As the size of a POP unit increases, carry handles or straps may advantageously be provided. However, POP units do not necessarily have carry handles or straps.

Furthermore, in some embodiments, a single bag or can may comprise more than one rotational pet-food formula. In these embodiments, different rotational pet-food formulas may be layered throughout a bag or can. Thus, in a bag comprising two rotational pet-food formulas—Formulas A and B—a pet may consume primarily Formula A upon opening a bag being opened and gradually transition to Formula B as the food in the bag is consumed. The only limit to the number of different rotational pet-food formulas that may be layered within a single bag or can is the size of the bag or can.

Embodiments comprising wet ingredients, dry ingredients, semi-moist ingredients, pet treats, rawhide chews or pet snacks may be presented in tray pack, sealed multi-unit boxes, or other packaging designs. For embodiments in which rotational pet-food formulas are packaged in cans, the cans may be joined together using plastic rings in the same manner that cans of soda are often joined together. In addition, for embodiments in which rotational pet-food formulas are packaged in cans, the cans may be placed in a tray or box system.

### BRIEF DESCRIPTION OF THE DRAWINGS

FIG. 1 is a flowchart illustrating an embodiment of a method of providing a rotational diet to a pet.

FIG. 2 is a flowchart illustrating an embodiment of a method of providing a rotational diet to a pet.

FIG. 3 is a flowchart illustrating an embodiment of a method of formulating and selling rotational pet-food formula.

FIG. 4 shows an embodiment of a multi-pack POP unit.

FIG. 5 shows a table that illustrates an example of a possible nutritional makeup of rotational formulas in certain embodiments.

FIG. 6 shows a table that illustrates an example of a possible ingredient profile of an embodiment comprising three rotational pet-food formulas.

### DETAILED DESCRIPTION OF THE PREFERRED EMBODIMENTS

Rotational pet-food formulas are provided that enable a pet owner to cycle a pet's diet through a sequence of different pet-food formulas developed to nutritionally complement one another. Each rotational pet-food formula is designed to minimize or eliminate any digestive issues that would otherwise occur when switching a pet's diet from one pet-food formula to the next.

A rotational pet-food system is comprised of two or more rotational pet-food formulas. The digestive compatibility and nutritional complementariness of each rotational pet-food formula in a rotational pet-food system enables the rotational pet-food system to deliver a more-comprehensive and balanced nutrient platform not found in any single pet-food formula. The individual rotational pet-food formulas comprising a rotational pet-food system work together as a complete nutritional system. Although the rotational pet-food formulas in a rotational pet-food system are designed to work together synergistically to deliver enhanced nutrition, each rotational pet-food formula is designed to individually meet the nutritional requirements of a pet and those set by the Association of American Feed Control Officials (AAFCO).

To ensure that all rotational pet-food formulas in a rotational pet-food system complement one another nutritionally, and to ensure that the transition from one rotational pet-food formula to the next will not cause digestive issues, each rotational pet-food formula in a rotational pet-food system may exhibit shared characteristics. First, each rotational pet-food formula may exhibit the same or substantially similar nutrient composition. For example, each rotational pet-food formula in a rotational pet-food system may advantageously comprise approximately the same percentage balance of proteins, fats, fibers, and carbohydrates. Second, each rotational pet-food formula may use complementary proteins, grains, fruits, fiber sources, vegetables, and chondroprotective agents. Third, each rotational pet-food formula may achieve consistent ingredient levels by leveling of proteins, fats, grains, fiber sources, vitamins, and minerals. Fourth, each rotational pet-food formula may utilize kibbles of consistent size, shape, and texture.

In some embodiments, the rotational pet-food formulas in a rotational pet-food system may be formulated to contain beneficial ingredients. For example, the formulas in a rotational pet-food system may comprise regular ingredients, or the formulas may comprise organic ingredients. In addition, some rotational pet-food formulas may be free of grains.

The rotational pet-food formulas in a rotational pet-food system are designed to deliver proper nutrient exposure. Formulating the rotational pet-food formulas with balanced levels of multiple protein sources helps to ensure proper nutrient exposure. In addition, formulating the rotational pet-food formulas with balanced levels of multiple carbohydrate sources also helps ensure proper nutrient exposure. Furthermore, formulating the rotational pet-food formulas using appropriate vitamins and minerals helps to ensure proper nutrition.

By limiting the number of ingredients in each rotational pet-food formula, it is possible to ensure adequate levels of each ingredient are used. Furthermore, limited ingredient crossover among rotational pet-food formulas in a rotational pet-food system ensures that the likelihood of over-saturation to ingredients is minimized.

In addition to nutritional benefits, feeding a pet a rotational diet that cycles among the rotational pet-food formulas in a rotational pet-food system offers a variety of flavor and ingredient sources that keep pets interested in proper feeding.

Although each rotational pet-food formula in a rotational pet-food system may be consumed in any order, advantageously the rotational pet-food formulas may be consumed in a particular order. After a cycle is completed by finishing each rotational pet-food formula in the rotational pet-food system, a new cycle may commence.

In some embodiments, a rotational pet-food system may be comprised of as few as two rotational pet-food formulas. In other embodiments, the rotational pet-food system may comprise three rotational pet-food formulas. However, there is no limit to the number of rotational pet-food formulas that may comprise a rotational pet-food system. For example, in some embodiments, a rotational pet-food system may be comprised of twelve rotational pet-food formulas. In some twelve-formula embodiments, the rotational pet food formulas may be formulated according to the varied nutritional needs of a pet by calendar month.

The quantity of rotational pet-food formula contained in each package, can, bag, box or other unit of rotational pet-food formula may vary by any amount. For example, in some embodiments, the rotational pet-food formulas may comprise a single-serving can or bag. In other embodiments, the rotational pet-food formulas may comprise a large multi-serving can or bag whose size is only limited by the ability of the can or bag to keep the rotational pet-food formulas fresh.

In some embodiments, the size of one or more packages of rotational pet-food formula in a rotational pet-food system may be different than the size of packages of other rotational pet-food formulas in that system. For example, in an embodiment of a rotational pet food system comprising three rotational pet-food formulas—Formulas A, B, and C—the size of a can or bag of Formula A may be twice the size of a can or bag of Formula B or C. In this embodiment, a pet may consume Formula A for 50% of a rotational pet-food cycle, Formula B for 25% of a rotational pet-food cycle, and Formula C for the remaining 25% of a rotational pet-food cycle.

In other embodiments, the size of packages of rotational pet-food formula in a rotational pet-food system may be equal. For example, in some embodiments, the size of cans or bags of a rotational pet-food system comprising Formulas A, B, and C may be equal, such that a pet may consume Formula A for 33% of a rotational pet-food cycle, Formula B for 33% of a rotational pet-food cycle, and Formula C for the remaining 33% of a rotational pet-food cycle.

The duration of a rotational pet-food cycle may be as short or as long as desired. For example, in some embodiments, the rotational pet-food system may comprise two rotational pet-food formulas which may be packaged in single-serving cans or bags. In one meal, the pet may eat a first rotational pet-food formula. In the next meal, the pet may eat the other rotational pet-food formula. In these embodiments, the rotational cycle is as short as two meal periods. These embodiments also achieve improved freshness because the cans or bags of rotational pet-food formula are not opened until they are ready to be consumed, and they are consumed in their entirety once opened.

In some embodiments, the duration of a rotational pet-food cycle may be relatively long. The three primary factors that determine the duration of a rotational pet-food cycle are the number of different rotational pet-food formulas that comprise a rotational pet-food system, the size of each bag of rotational pet-food formula, and the serving size of each pet-food formula that is fed to the pet. The duration of a rotational pet-food cycle may be increased by utilizing larger bags to hold each rotational pet-food formula.

In some embodiments, the rotational pet-food formulas of a rotational pet-food system may comprise dry ingredients. In other embodiments, the rotational pet-food formulas of a rotational pet-food system may comprise wet ingredients. Rotational pet-food formulas comprising wet ingredients may be sold in cans. Rotational pet-food formulas packaged in cans may be sold individually or in multi-packs comprising any number of cans. In addition, in other embodiments, a rotational pet-food system may comprise rotational pet-food formulas comprising dry ingredients that are rotationally compatible with other rotational pet-food formulas comprising wet or semi-moist ingredients. These embodiments advantageously offer a pet variety between dry food, wet food, and semi-moist food.

In other embodiments, the rotational pet-food formulas of a rotational pet-food system may include, but are not limited to, semi-moist pet food, pet treats, rawhide chews and pet snacks.

Rotational pet-food systems can be formulated for any type and breed of pet. Although dogs and cats are the most common pets for which many rotational pet-food systems would be formulated, rotational pet-food systems can also be formulated for other mammals, reptiles, birds, fish, and amphibians. Furthermore, rotational pet-food systems can be formulated for any breed of dog or cat.

In addition, rotational pet-food systems can be formulated for pets of any age range. For example, different rotational pet-food systems can be formulated for puppies, adult dogs, senior dogs, as well as kittens, adult cats, and senior cats. Furthermore, rotational pet-food systems can be formulated according to activity lifestyle. For example, one rotational pet-food system can be formulated for an indoor dog or cat, while a different rotational pet-food system can be formulated for an outdoor dog or cat.

Each rotational pet-food formula comprising a rotational pet-food system may be individually packaged in its own bag or can. Packaging of rotational pet-food formulas may comprise many materials, including paper, plastic, aluminum, steel, woven materials, coated materials, and lined materials. Individual packaging of each bag or can of rotational pet-food formula enhances freshness because each bag or can need not be opened until the previous pet-food formula in the rotational cycle is finished.

Each bag or can of rotational pet-food formula in a rotational pet-food system may be packaged together as a multi-pack to form a single point-of-purchase (POP) unit. Offering every bag or can of rotational pet-food formula in a rotational pet-food system in a single POP unit provides increased convenience for consumers. The POP unit may be put together as a package, carton, or any other container. The POP unit may offer added protection for the individual bags or cans of rotational pet-food formula. Also, the POP units may be designed to reduce shelf space. In addition, the POP units may have carry handles or straps designed to facilitate transport of the POP unit by consumers. As the size of a POP unit increases, carry handles or straps may advantageously be provided. However, POP units do not necessarily have carry handles or straps.

Furthermore, in some embodiments, a single bag or can may comprise more than one rotational pet-food formula. In these embodiments, different rotational pet-food formulas may be layered throughout a bag or can. Thus, in a bag comprising two rotational pet-food formulas—Formulas A and B—a pet may consume primarily Formula A upon opening a bag being opened and gradually transition to Formula B as the food in the bag is consumed. The only limit to the number of different rotational pet-food formulas that may be layered within a single bag or can is the size of the bag or can.

Embodiments comprising wet ingredients, dry ingredients, semi-moist ingredients, pet treats, rawhide chews or pet snacks may be presented in tray pack, sealed multi-unit boxes, or other packaging designs. For embodiments in which rotational pet-food formulas are packaged in cans, the cans may be joined together using plastic rings in the same manner that cans of soda are often joined together. In addition, for embodiments in which rotational pet-food formulas are packaged in cans, the cans may be placed in a tray or box system.

Embodiments of the invention will now be described with reference to the accompanying Figures, wherein like numerals refer to like elements throughout. The terminology used in the description presented herein is not intended to be interpreted in any limited or restrictive manner, simply because it is being utilized in conjunction with a detailed description of certain specific embodiments of the invention. Furthermore, embodiments of the invention may include several novel features, no single one of which is solely responsible for its desirable attributes or which is essential to practicing the inventions described herein.

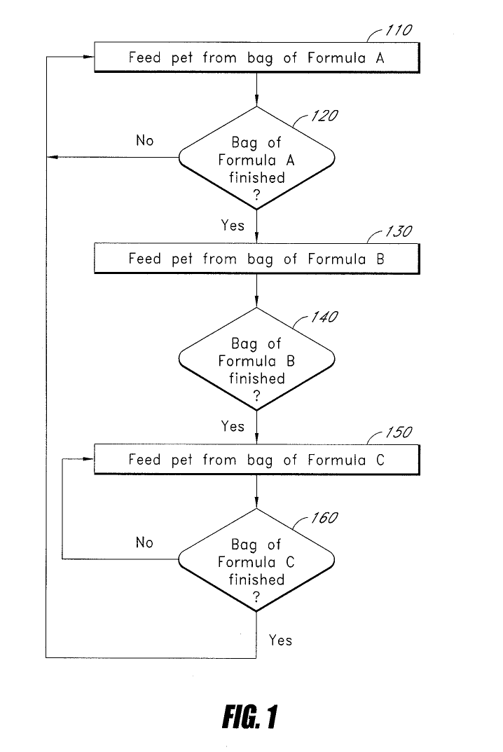

FIG. 1 is a flowchart illustrating a method of feeding a pet rotational pet-food formula from a rotational pet-food system that may be performed by a pet owner in order to provide a rotational diet to a pet. The rotational pet-food system depicted in FIG. 1 comprises three rotational pet-food formulas: Formula A, Formula B, and Formula C. Formulas A, B, and C are each formulated to be digestively compatible with each other and to nutritionally complement each other. Depending on the embodiment, the method of FIG. 1 may be practiced with a rotational pet-food system comprising a smaller number of rotational pet-food formulas (e.g., Formula A and B) or a larger number of rotational pet-food formulas (e.g., Formula A, B, C, D, etc.).

Beginning in block 110, the pet owner feeds his or her pet a serving of pet food from the bag of Formula A.

Moving to block 120, the pet owner observes whether the bag of Formula A is finished. If the bag of Formula A is not finished, the pet owner repeats the step of block 110, and the pet owner continues to feed his or her pet servings of pet food from the bag of Formula A. If the bag of Formula A is finished, the pet owner proceeds to perform the step of block 130.

Continuing to block 130, the pet owner opens the bag of Formula B and feeds his or her pet a serving of pet food from the bag of Formula B. Because Formula B is digestively compatible with Formula A, no pet food from the bag of Formula A is required to be mixed with the bag of Formula B in order to avoid digestive problems in the pet.

Moving to block 140, the pet owner observes whether the bag of Formula B is finished. If the bag of Formula B is not finished, the pet owner repeats the step of block 130, and the pet owner continues to feed his or her pet servings of pet food from the bag of Formula B. If the bag of Formula B is finished, the pet owner proceeds to perform the step of block 150.

Next, in block 150, the pet owner opens the bag of Formula C and feeds his or her pet a serving of pet food from the bag of Formula C. Because Formula C is digestively compatible with Formula B, no pet food from the bag of Formula B is required to be mixed with the bag of Formula C in order to avoid digestive problems in the pet.

In block 160, the pet owner observes whether the bag of Formula C is finished. If the bag of Formula C is not finished, the pet owner repeats the step of block 150, and the pet owner continues to feed his or her pet servings of pet food from the bag of Formula C. If the bag of Formula C is finished, the pet owner proceeds back to perform the step of block 110. In block 110, the pet owner will open a new bag of Formula A, and the rotational pet-food cycle repeats. Because Formula A is digestively compatible with Formula C, no pet food from the bag of Formula C is required to be mixed with the bag of Formula A in order to avoid digestive problems in the pet.

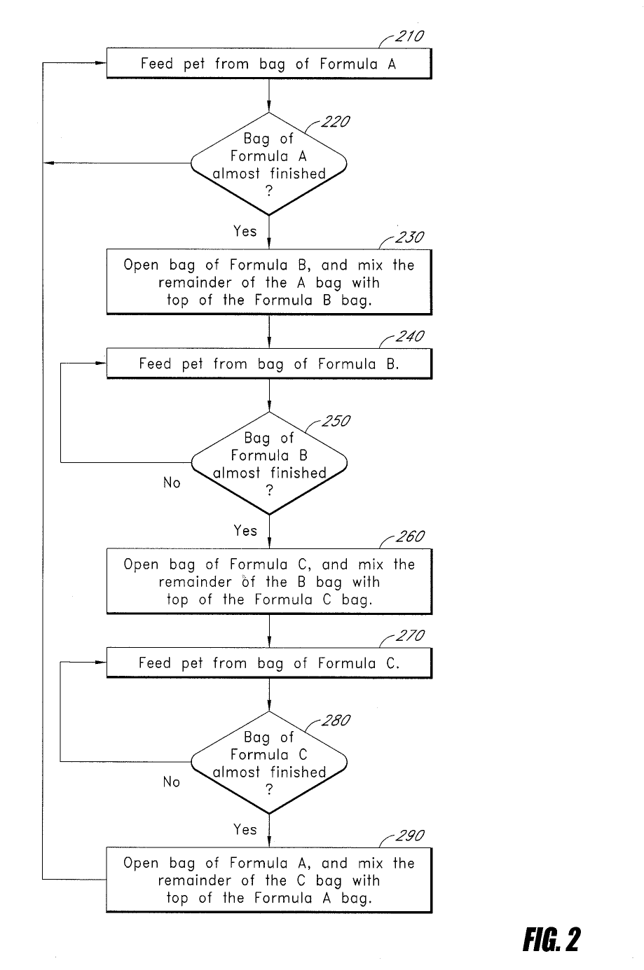

FIG. 2 is a flowchart illustrating a method of feeding a pet rotational pet-food formula from a rotational pet-food system that may be performed by a pet owner in order to provide a rotational diet to a pet. Like the rotational pet-food system depicted in FIG. 1, the rotational pet-food system depicted in FIG. 2 comprises three rotational pet-food formulas: Formula A, Formula B, and Formula C. Formulas A, B, and C are each formulated to be digestively compatible with each other and to nutritionally complement each other. Depending on the embodiment, the method of FIG. 2 may be practiced with a rotational pet-food system comprising a smaller number of rotational pet-food formulas (e.g., Formulas A and B) or a larger number of rotational pet-food formulas (e.g., Formulas A, B, C, D, etc.).

Beginning in block 210, the pet owner feeds his or her pet a serving of pet food from the bag of Formula A.

Moving to block 220, the pet owner observes whether the bag of Formula A is almost finished. If the bag of Formula A is not almost finished, the pet owner repeats the step of block 210, and the pet owner continues to feed his or her pet servings of pet food from the bag of Formula A. If the bag of Formula A is almost finished, the pet owner proceeds to perform the step of block 230. For example, if the quantity of pet food remaining in the bag of Formula A is not enough for a complete feeding, the pet owner may proceed to perform the step of block 230.

Continuing to block 230, the pet owner opens the bag of Formula B and mixes the remainder of the bag of Formula A with the pet food at the top of the bag of Formula B. This mixing step further contributes to digestive compatibility. Although Formula B is formulated for digestive compatibility with Formula A, mixing may further enhance digestive compatibility, which may be beneficial to pets having unusually sensitive digestive systems.

Next, in block 240, the pet owner feeds his or her pet a serving of pet food from the bag of Formula B.

Moving to block 250, the pet owner observes whether the bag of Formula B is almost finished. If the bag of Formula B is not almost finished, the pet owner repeats the step of block 240, and the pet owner continues to feed his or her pet servings of pet food from the bag of Formula B. If the bag of Formula B is almost finished, the pet owner proceeds to perform the step of block 260. For example, if the quantity of pet food remaining in the bag of Formula B is not enough for a complete feeding, the pet owner may proceed to perform the step of block 260.

Continuing to block 260, the pet owner opens the bag of Formula C and mixes the remainder of the bag of Formula B with the pet food at the top of the bag of Formula C. This mixing step further contributes to digestive compatibility. Although Formula C is formulated for digestive compatibility with Formula B, mixing may further enhance digestive compatibility, which may be beneficial to pets having unusually sensitive digestive systems.

Next, in block 270, the pet owner feeds his or her pet a serving of pet food from the bag of Formula C.

Moving to block 280, the pet owner observes whether the bag of Formula C is almost finished. If the bag of Formula C is not almost finished, the pet owner repeats the step of block 270, and the pet owner continues to feed his or her pet servings of pet food from the bag of Formula C. If the bag of Formula C is almost finished, the pet owner proceeds to perform the step of block 290. For example, if the quantity of pet food remaining in the bag of Formula C is not enough for a complete feeding, the pet owner may proceed to perform the step of block 290.

Continuing to block 290, the pet owner opens a new bag of Formula A and mixes the remainder of the bag of Formula C with the pet food at the top of the bag of Formula A. This mixing step further contributes to digestive compatibility. Although Formula A is formulated for digestive compatibility with Formula C, mixing may further enhance digestive compatibility, which may be beneficial to pets having unusually sensitive digestive systems. The pet owner then proceeds to step 210, and the rotational pet-food cycle repeats.

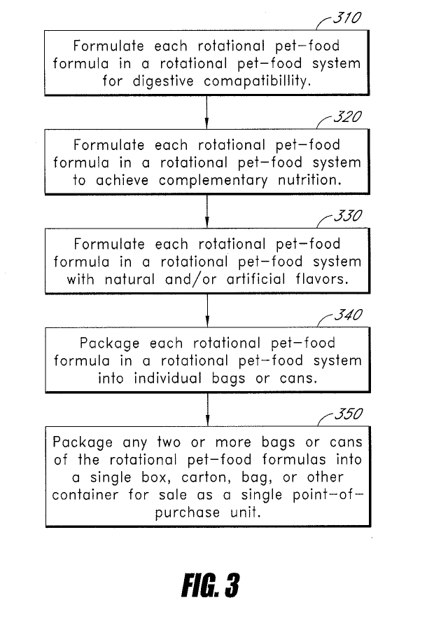

FIG. 3 is a flowchart illustrating a method of formulating and selling rotational pet-food formula. The flowchart of FIG. 3 applies to any rotational pet-food system comprising two or more rotational pet-food formulas.

Beginning in block 310, each rotational pet-food formula in a rotational pet-food system is formulated to ensure digestive compatibility with every other rotational pet-food formula in the system. Digestive compatibility is accomplished in part through consistency in the level of proteins, fats, grains, fruits, fiber sources, vitamins, and minerals. Digestive compatibility may be achieved if the levels of these ingredients vary by no more than 10% between different rotational formulas in a system; however, this percentage may be increased or decreased and remain within the scope of the present disclosure.

Continuing to block 320, each rotational pet-food formula in a rotational pet-food system is formulated to achieve complementary nutrition. Complementary nutrition is accomplished in part by selecting ingredients—proteins (meats and meat sources), fats, grains, starches, fruits, fiber sources, vegetables, vitamin additives, mineral additives, and chondroprotective agents—for each rotational pet-food formula that nutritionally complement the ingredients in the other rotational pet-food formulas in the system. Primarily the protein ingredients for each rotational pet-food formula comprise poultry, beef, lamb, pork, or fish.

Next, in block 330, each rotational pet-food formula in a rotational pet-food system may be formulated with additional natural and/or artificial flavors. These flavor additives help promote flavor variety that keeps the pet interested in proper feeding.

Moving to block 340, each rotational pet-food formula in a rotational pet-food system is packaged into individual bags or cans. The individual bags or cans of rotational pet-food formula may comprise paper, plastic, aluminum, steel, woven materials, coated materials, and linen materials, or any other materials with which pet-food bags or cans may be made. Packaging each rotational pet-food formula in an individual bag or can advantageously contributes to the freshness of each bag because each bag or can need not be opened until the bag or can containing the previous pet-food formula in the rotational cycle is finished.

In block 350, any two or more bags or cans of rotational pet-food formula in a rotational pet-food system may be packaged into a single box, carton, bag, or other container for sale as a single POP unit. Offering two or more bags or cans of rotational pet-food formula for sale in a single POP unit provides increased convenience for consumers. The multi-pack POP container may also offer added protection for the individual bags or cans of rotational pet-food formula, acting as a buffer to minimize the breakage of kibbles. In addition, the POP units may have carry handles or straps designed to facilitate transport of the POP carton by consumers.

The multi-pack POP units also offer benefits to a pet-food retailer. For example, the multi-pack POP units may be designed to reduce shelf space. Also, the multi-pack POP units may benefit retailers by reducing the number of stock keeping units (SKUs) they are required to maintain.

Alternatively, bags or cans of each rotational pet-food formula in a rotational pet-food system may be sold individually. To facilitate individual sale, each rotational pet-food system may have unique identifiers that are located on each bag or can of rotational pet-food formula in a particular rotational pet-food system that enables consumers to easily find and choose bags or cans of rotational pet-food formula belonging to a single rotational pet-food system. For example, the color of bags or cans may be used as the unique identifier of a particular rotational pet-food system. Also, text may be used as the unique identifier of a particular rotational pet-food system. In particular, the size, font, and location of the text may be used as the unique identifier of a particular rotational pet-food system.

It should be understood that it is not necessary to practice any particular block of FIG. 3. Any combination of blocks 310, 320, 330, 340, and 350 may be omitted, and the remaining blocks may be practiced together.

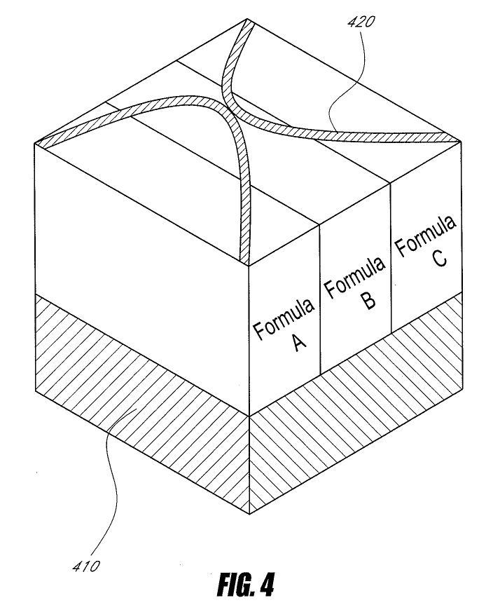

FIG. 4 shows an embodiment of a multi-pack POP unit for a rotational pet-food system comprising three rotational pet-food formulas—Formula A, Formula B, and Formula C. In FIG. 4, container 410 holds the bags of Formula A, Formula B, and Formula C together as a single unit. Container 410 may be comprised of cardboard or plastic. Handles 420 attach to container 410 and allow for convenient transport of container 410. Carry handles may also be formed by indentations or holes in container 410 that allow container 410 to be grasped by a person's fingers or hands.

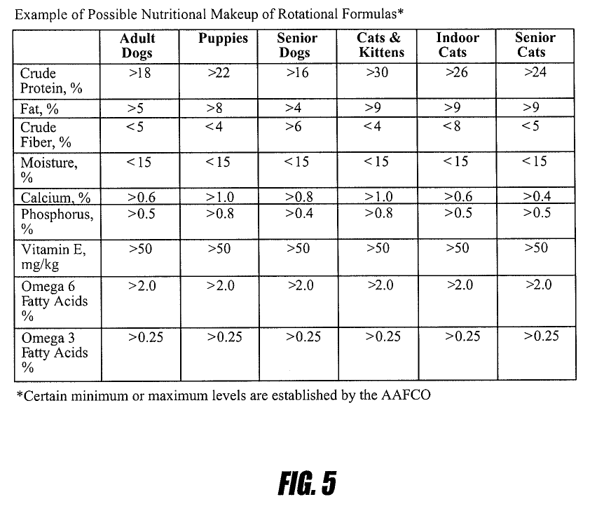

FIG. 5 shows a table that illustrates an example of a possible nutritional makeup of the rotational pet-food formulas for embodiments designed for adult dogs, puppies, senior dogs, cats and kittens, indoor cats, and senior cats.

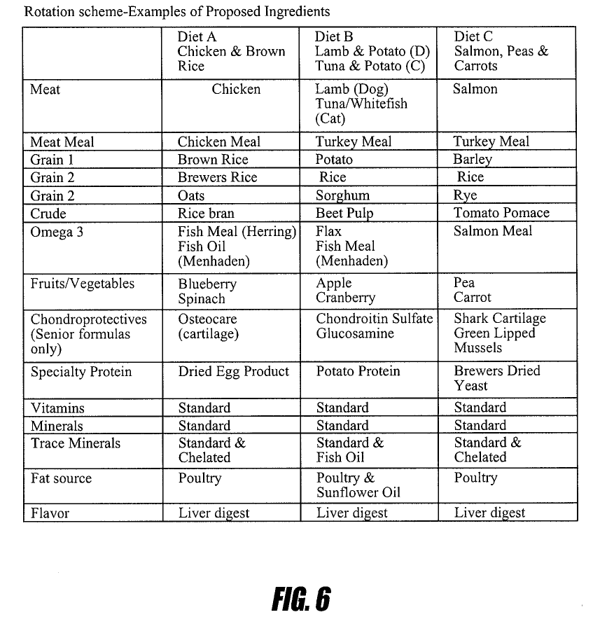

FIG. 6 shows a table that illustrates an example of a possible ingredient profile of an embodiment for a rotational pet-food system comprising three rotational pet-food formulas.

What follows is a description of examples of possible rotational pet-food formulations for embodiments for a rotational pet-food system that comprises three rotational pet-food formulas—Formula A, Formula B, and Formula C.

In one embodiment the rotational formulas may be designed for all dogs, with an emphasis on adult dogs from one year of age or older with normal activity levels. Specifically, as an example, the adult dog rotational formulas may comprise:

All

Formulated for all life stages
Moderate levels of protein and fat
Fermentable fibers to support gastrointestinal health and stool consistency
Mix of whole grains—for readily available energy and complex carbohydrates

Formula A
Herring—Omega 3 fatty acids from North Atlantic Fish (Herring meal)—Supports healthy immune system
Blueberries & Spinach—Natural source of antioxidants

Formula B
Flax—Omega 3 fatty acids from Flax and Gulf sea fish (Menhaden Fish meal)—Supports healthy skin & coat
Cranberry & Apples—Natural source of complex carbohydrates
Iodine from Kelp

Formula C
Salmon (meat and meal)—Omega 3 fatty acids—Nutritional support for limited inflammation
Peas & Spinach—Natural source of carotenoids
Iodine from iodized salt

In one embodiment the rotational formulas may be designed for puppies, with an emphasis on supporting normal puppy growth. The puppy rotational formulas may place special attention on calcium and phosphorous nutrition. The puppy rotational formulas would also suffice for a large-breed puppy application if daily feeding allowances were limited so as to control growth rates. Special emphasis is placed not only on provision of higher quality proteins, but also on the mix of fatty acids with the provision of DHA for brain and eye tissue development. Specifically, as an example, the puppy rotational formula may comprise:

All
Formulated for growth and reproduction
Fortified with docosahexaenoic acid (DHA) for brain and neurological development
High Quality proteins—for development of strong muscles

Formula A
Egg—Natures perfect protein
Blueberries & Spinach—Natural source of antioxidants

Formula B
Protein as a high quality complementary protein
Apple & Cranberry—Natural source of complex carbohydrates

Formula C
Brewers Dried Yeast—rich in nucleic acids
Pea & Carrot—Natural source of carotenoids

In one embodiment the rotational formulas may be designed for senior dogs. The rotational formulas for senior dogs are formulated with the awareness that older dogs are less active so they don't require the level of calories of a maintenance food, but that these calories should preferably be reduced in the form of fat but not in protein. The senior dog formulas may also be fortified with chondroitin sulfate, glucosamine, and vitamin C to promote healthy joints. Specifically, as an example, the senior dog rotational formulas may comprise:

All
Formulated for maintenance
Reduced Fat
Rich in antioxidants vitamins E and C

Formula A
Natural Chicken Cartilage—A rich source of naturally occurring glucosamine
Blueberry & Spinach—Natural source of antioxidants

Formula B
Choindroitin Sulfate and Glucosamine—building blocks for health joints and ligaments
Apple & Cranberry—Natural source of complex carbohydrates

Formula C
Shark Cartilage and Green lipped mussels—to support joint health
Pea & Carrot—Natural source of carotenoids

In one embodiment the rotational formulas may be designed for cats and kittens. The cat and kitten rotational formulas are designed for all life stages, from weaning through adult-hood. The cat and kitten rotational formulas form a higher protein and fat diet that will support growth and development of the kitten, and adult cats can thrive on as well as portions are reduced commensurate with their declining activity for maintenance of weight. In addition, the elevated level of protein and controlled level of ash will aid in the healthy maintenance of the urinary tract. Specifically, as an example, the cat and kitten rotational formulas may comprise:

All
Formulated for all life stages (growth, reproduction, and adult maintenance)
Formulated to support urinary tract health
Rich source of animal based proteins to nourish the developing carnivore

Formula A
erring Meal and Menhaden Oil—Omega 3 fatty acids—Supports healthy immune system
Blueberries & Spinach—Natural source of antioxidants

Formula B
Flax and Menhaden Fish Meal—Omega 3 fatty acids—Supports healthy skin & coat
Cranberry & Apples—Natural source of complex carbohydrates

Formula C
Salmon (Meat and Meal)—Omega fatty acids—Nutritional support for limited inflammation
Peas & Carrots—Natural source of carotenoids

In one embodiment the rotational formulas may be designed for indoor cats. The indoor-cat rotational formulas are designed as a maintenance diet, and are particularly beneficial in a multiple-cat household with a mix of cats, some of which may be overweight. The indoor-cat rotational formulas are a lower-calorie diet that qualifies for the “low fat” designation. It provides a moderate level of protein, with low fat level, and elevated levels of insoluble fiber to lower caloric density and to aid in the passage of digesta, thereby reducing the occurrence of hair-balls. The indoor-cat rotational formulas may also be fortified with carnitine to promote metabolism of fat. Specifically, as an example, the indoor-cat rotational formula may comprise:

All
Formulated for maintenance
Low Fat
Fortified with carnitine to aid normal fat metabolism
Enriched with fiber to aid food passage and consistent elimination

Formula A
Rice bran—source of fermentable fiber
Blueberries & Spinach—Natural source of antioxidants

Formula B
Beet pulp—source of fermentable fiber
Cranberry & Apple—Natural source of complex carbohydrates

Formula C
Tomato pomace—source of fermentable fiber
Peas & Carrots—Natural source of carotenoids

In one embodiment the rotational formulas may be designed for senior cats. The senior cat rotational formulas are a lower-calorie version of the Cat and Kitten formulas that are designed for the aging cat that requires protein for the maintenance of lean body mass, but doesn't need as many fat calories because of lower activity levels. Specifically, as an example, the senior-cat rotational formula may comprise:

All
Formulated for adult maintenance
Rich in quality proteins
Low Fat
Rich in antioxidants vitamins E and C

Formula A
Rich in natural chicken proteins
Blueberries & Spinach—Natural source of antioxidants

Formula B
Rich in lamb proteins
Cranberry & Apples—Natural source of complex carbohydrates

Formula C
Rich in salmon and pork proteins
Peas & Carrots—Natural source of carotenoids

Various rotational pet-food formulas have been disclosed in detail in connection with various embodiments. These embodiments are disclosed by way of examples only and are not to limit the scope of the disclosure. One of ordinary skill in the art will appreciate the many variations, modifications, and combinations. For example, each ingredient disclosed in each rotational pet-food formula may be substituted with one or more other ingredients. In addition, listed ingredients may be deleted or other ingredients may be added and still fall within the scope of the present invention.

The foregoing description details certain embodiments of the invention. It will be appreciated, however, that no matter how detailed the foregoing appears in text, the invention can be practiced in many ways. The use of particular terminology when describing certain features or aspects of the invention should not be taken to imply that the terminology is being re-defined herein to be restricted to including any specific characteristics of the features or aspects of the invention with which that terminology is associated.

What is claimed is:

1. A method of feeding a pet, the method comprising:
feeding a pet a first formula during a first period of time; and
feeding a pet a second formula during a second period of time, wherein the second formula is formulated to achieve complementary nutritional and digestive compatibility with the first formula.

2. The method of claim 1, further comprising feeding a pet a third formula during a third period of time, wherein the third formula is formulated to achieve complementary nutritional and digestive compatibility with the first formula and the second formula.

3. The method of claim 1, wherein the first formula and the second formula have substantially similar nutrient composition.

4. The method of claim 1, wherein the first formula and the second formula comprise approximately the same percentage balance of proteins, fats, fibers, and carbohydrates.

5. The method of claim 1, wherein the first formula and the second formula comprise complementary proteins, grains, fruits, fiber sources and vegetables.

6. The method of claim 1, wherein the first formula and the second formula comprise kibbles of similar size, shape and texture.

7. The method of claim 1, wherein the first formula and the second formula comprise organic ingredients.

8. The method of claim 1, wherein the first formula and the second formula are packaged in independent containers.

9. The method of claim 1, wherein the first formula and the second formula are each packaged in a single container.

10. The method of claim 1, wherein the first formula is packaged in a first can or bag and the second formula is packaged in a second can or bag, wherein the can or bag of the first formula and can or bag of the second formula are packaged as a single point-of-purchase unit.

11. The method of claim 10, wherein the single point-of-purchase unit comprises carry handles.

12. The method of claim 1, wherein the first formula and the second formula comprise dry ingredients.

13. The method of claim 1, wherein the first formula and the second formula comprise wet ingredients.

14. The method of claim 1, wherein one of the first or second formulas comprises dry ingredients and one of the first or second formulas comprises wet ingredients.

15. The method of claim 1, wherein the first formula and the second formula are formulated for consumption by a dog.

16. The method of claim 15, wherein the first formula and the second formula are formulated for consumption by a particular breed of dog.

17. The method of claim 1, wherein the first formula and the second formula are formulated for consumption by a cat.

18. The method of claim 1, wherein the first formula and the second formula are formulated according to the nutritional needs of a young pet.

19. The method of claim 1, wherein the first formula and the second formula are formulated according to the nutritional needs of a senior pet.

20. The method of claim 1, wherein the first formula and the second formula comprise chondroprotective agents.

21. The method of claim 1, wherein the first and second periods of time at least partially overlap.

22. A method of feeding a pet, the method comprising:
feeding a pet a first formula from a first container;
feeding the pet a second formula from a second container after the pet has consumed most or all of the first formula from the first container, wherein the second formula is formulated to achieve complementary nutritional and digestive compatibility with the first formula; and
feeding the pet a third formula from a third container after the pet has consumed most or all of the second formula from the second container, wherein the third formula is formulated to achieve complimentary nutritional and digestive compatibility with the first formula and the second formula.

23. A method of feeding a pet, the method comprising:
feeding a pet a first formula from a first container;
mixing a remainder of the first formula from the first container with a second formula from a second container, wherein the first container is substantially empty and the second container is substantially full at the time of mixing, wherein the second formula is formulated to achieve complementary nutritional and digestive compatibility with the first formula;
feeding the pet food from the second container;
mixing a remainder of the second container with a third formula from a third container, wherein the second container is substantially empty and the third container is substantially full at the time of mixing, wherein the third formula is formulated to achieve complementary nutritional and digestive compatibility with the second formula; and
feeding the pet food from the third container.

24. The method of claim 23, further comprising:
mixing a remainder of the third container with a fourth container comprising the first formula, wherein the third container is substantially empty and the fourth container is substantially full at the time of mixing; and
feeding the pet food from the fourth container.

25. A method of formulating and packaging rotational pet-food formulas, the method comprising:
formulating each rotational pet-food formula in a rotational pet-food system for digestive compatibility;
formulating each rotational pet-food formula in a rotational pet-food system to achieve complementary nutrition;
formulating each rotational pet-food formula in a rotational pet-food system with natural and/or artificial flavors;
packaging each rotational pet-food formula in a rotational pet-food system into individual bags or cans;
packaging any two or more bags or cans of the rotational pet-food formulas into a single box, carton, bag, or other container for sale as a single point-of-purchase unit.
